(19) United States
(12) Patent Application Publication
(10) Pub. No.: US 2021/0239485 A1
(43) Pub. Date: Aug. 5, 2021

(54) SYSTEM AND METHOD FOR VEHICLE NAVIGATION USING TERRAIN TEXT RECOGNITION

(71) Applicant: GM GLOBAL TECHNOLOGY OPERATIONS LLC, Detroit, MI (US)

(72) Inventors: Farui Peng, Sterling Heights, MI (US); Kai-Han Chang, Madison Heights, MI (US); Wei Tong, Troy, MI (US)

(73) Assignee: GM GLOBAL TECHNOLOGY OPERATIONS LLC, Detroit, MI (US)

(21) Appl. No.: 16/782,683

(22) Filed: Feb. 5, 2020

(51) Int. Cl. G01C 21/36; G08G 1/0962; G06K 9/00; G06K 9/62; G06F 3/01; G05D 1/02

(52) U.S. Cl. CPC G01C 21/3602; G08G 1/09623; G08G 1/09626; G06K 9/00791; G06K 9/6257; G06K 2209/01; G06F 3/013; G05D 1/0274; G05D 1/0278; G01C 21/365; G06K 9/00671

(57) ABSTRACT

A method of vehicle navigation using terrain text recognition includes receiving, via an electronic controller arranged on a vehicle and having access to a map of the terrain, a navigation route through the terrain. The method also includes receiving, via the controller, a signal from a global positioning system (GPS) to determine a current position of the vehicle relative to the terrain. The method additionally includes determining, via the controller, a location of a next waypoint on the navigation route and relative to the current vehicle position. The method also includes detecting and communicating to the controller, via a vehicle sensor an image frame displaying a text indicative of the next waypoint and correlating, via the controller, the detected text to the next waypoint on the map. Furthermore, the method includes setting, via the controller, an in-vehicle alert indicative of the detected text having been correlated to the next waypoint.

### INTRODUCTION

The present disclosure relates to a system and a method for navigation of a motor vehicle using terrain text recognition.

A vehicle navigation system may be part of integrated vehicle controls or an add-on apparatus used to find direction in the vehicle. Vehicle navigation systems are crucial for the development of vehicle automation, i.e., self-driving cars. Typically, a vehicle navigation system uses a satellite navigation device to obtain its position data, which is then correlated to the vehicle's position relative to a surrounding geographical area. Based on such information, when directions to a specific waypoint are needed, routing to such a destination may be calculated. On-the-fly traffic information may be used to adjust the route.

Current position of a vehicle may be calculated via dead reckoning—by using a previously determined position and advancing that position based upon known or estimated speeds over elapsed time and course. Distance data from sensors attached to the vehicle's drivetrain, e.g., gyroscope and accelerometer, and vehicle mounted radar and optical equipment may be used for greater reliability and to counter global positioning system (GPS) satellite signal loss and/or multipath interference due to urban canyons or tunnels. In urban and suburban settings, locations of landmarks, sights, and various attractions are frequently identified via signs employing textual description or formal name of the point of interest.

### SUMMARY

A method of vehicle navigation using terrain text recognition includes receiving, via an electronic controller arranged on a vehicle and having access to a map of the terrain, a navigation route through the terrain. The method also includes receiving, via the controller, a signal from a global positioning system (GPS) and using the signal to determine a current position of the vehicle relative to the terrain. The method additionally includes determining, via the electronic controller, a location of a next waypoint on the navigation route and relative to the current position of the vehicle. The method also includes detecting and communicating to the electronic controller, via a sensor arranged on the vehicle an image frame displaying a text indicative of the next waypoint. The method additionally includes correlating, via the electronic controller, the detected text to the next waypoint on the map of the terrain. Furthermore, the method includes setting, via the electronic controller, an in-vehicle alert indicative of the detected text having been correlated to the next waypoint.

The method may also include determining a distance from the current position to the determined location of the next waypoint.

Additionally, the method may include determining whether the distance from the current position to the determined location of the next waypoint is within a threshold distance.

According to the method, setting the in-vehicle alert may be accomplished when the distance from the current position to the determined location of the next waypoint is within the threshold distance.

According to the method, correlating the detected text to the next waypoint on the map of the terrain may include using a trained Neural Network architecture.

The Neural Network architecture may be a unified Neural Network structure configured to recognize the image frame. The unified Neural Network structure may include a fully-convolutional first Neural Network having an image input and at least one layer, and configured to recognize the text. The unified Neural Network structure may also include a convolutional second Neural Network having a text input and at least one layer. In such a structure, an output from the at least one layer of the second Neural Network may be merged with the at least one layer of the first Neural Network. The first and second Neural Networks may be trained together to output a mask score.

According to the method, setting the in-vehicle alert indicative of the detected text having been correlated to the next waypoint on the map of the terrain may include projecting, via a head-up display (HUM a highlight icon representative of the mask score onto a view of the next waypoint.

The method may also include determining a field of vision of an occupant of the vehicle and setting the in-vehicle alert in response to the determined field of vision.

According to the method, determining the field of vision may include detecting an orientation of a vehicle occupant's eyes. In such an embodiment, the in-vehicle alert may include projecting the highlight icon in response to the detected orientation of the vehicle occupant's eyes.

According to the method, setting the in-vehicle alert may include triggering an audible signal when the next waypoint appears in the determined field of vision.

A system for vehicle navigation using terrain text recognition and employing the above-described method is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a plan view of a motor vehicle traversing a geographical area; the vehicle employing a system for vehicle navigation using terrain text recognition, according to the present disclosure.

FIG. 2 is a schematic depiction of a view out of the motor vehicle, shown in FIG. 1, approaching and detecting via a sensor arranged on the vehicle, an image frame displaying a text indicative of an encountered waypoint, according to the present disclosure.

FIG. 3 is a depiction of a trained Neural Network architecture used by the system for vehicle navigation using terrain text recognition.

FIG. 4 is a schematic depiction of the system for vehicle navigation operating inside the cabin of the motor vehicle to set an alert indicative of the detected text correlated to the encountered waypoint, according to the present disclosure.

FIG. 5 is a flow diagram of a method of vehicle navigation using the system for vehicle navigation shown in FIGS. 1-4, according to the present disclosure.

### DETAILED DESCRIPTION

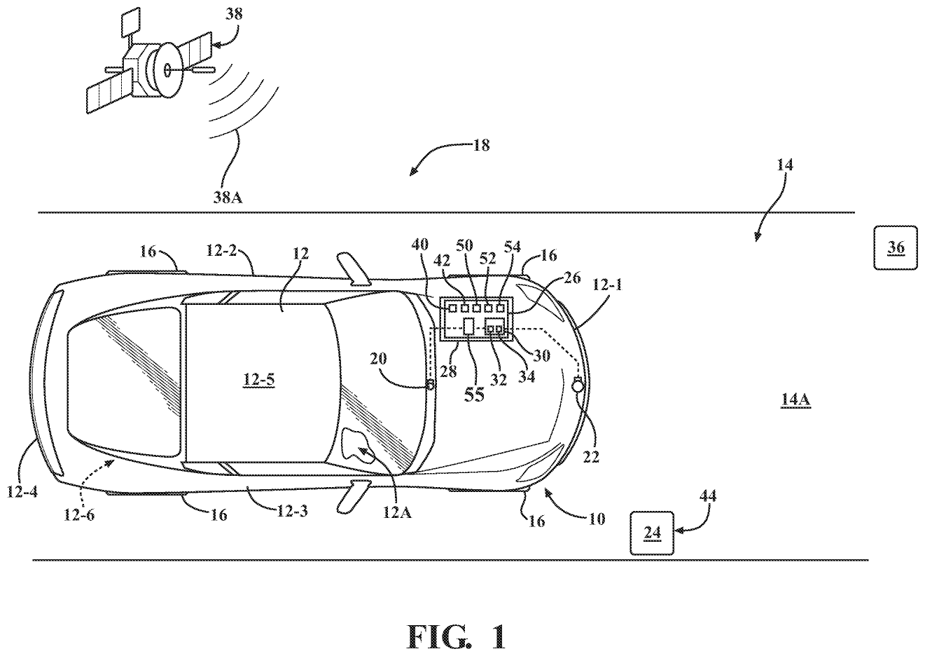

Referring to the drawings, wherein like reference numbers refer to like components, FIG. 1 shows a schematic view of a motor vehicle 10. As shown, the autonomous motor vehicle 10 has a vehicle body 12. The vehicle body 12 may have a leading side or front end 12-1, a left body side 12-2, right body side 12-3, a trailing side or back end 12-4, a top side or section, such as a roof, 12-5, and a bottom side or undercarriage 12-6. The vehicle body 12 generally defines a cabin 12A for an operator and passengers of the vehicle 10. The vehicle 10 may be used to traverse a geographical area, which includes a specific landscape or terrain 14 with associated roads and physical objects, such as residential complexes, places of business, landmarks, sights, and attractions.

As shown in FIG. 1, the vehicle 10 may include a plurality of road wheels 16. Although four wheels 16 are shown, a vehicle with fewer or greater number of wheels, or having other means, such as tracks (not shown), of traversing the road surface 14A or other portions of the geographical area is also envisioned. For example, and as shown in FIG. 1, the vehicle 10 may use a data gathering and processing system 18, which may be a perception and guidance system employing mechatronics, artificial intelligence, and a multi-agent system to assist the vehicle's operator. The data gathering and processing system 18 may be used to detect various objects or obstacles in the path of the vehicle 10. The system 18 may employ such features and various sources of data for complex tasks, especially navigation, to facilitate guidance of the vehicle 10, for example while traversing the geographical area and the terrain 14.

As shown in FIG. 1, as part of the data gathering and processing system 18, a first vehicle sensor 20 and a second vehicle sensor 22 are arranged on the vehicle body 12 and used as sources of data to facilitate advanced driver assistance or autonomous operation of the vehicle 10. Such vehicle sensors 20 and 22 may, for example, include acoustic or optical devices mounted to the vehicle body 12, as shown in FIG. 1. Specifically, such optical devices may be either emitters or collectors/receivers of light mounted to one of the vehicle body sides 12-1, 12-2, 12-3, 12-4, 12-5, and 12-6. The first and second vehicle sensors 20, 22 are depicted as part of the system 18, and may be part of other system(s) employed by the vehicle 10, such as for displaying a 360-degree view of immediate surroundings within the terrain 14. Notably, although the first and second sensors 20, 22 are specifically disclosed herein, nothing precludes a greater number of individual sensors being employed by the data gathering and processing system 18.

Specifically, an optical device may be a laser beam source for a Light Detection and Ranging (LIDAR) system, or a laser light sensor for an adaptive cruise control system or a camera capable of generating video files. In an exemplary embodiment of the system 18, the first vehicle sensor 20 may be a camera and the second vehicle sensor 22 may be a LIDAR. In general, each of the first and second vehicle sensors 20, 22 is configured to detect the immediate surroundings of the terrain 14, including, for example, an object 24 positioned external to the vehicle 10. The object 24 may be a specific point of interest, such as a landmark, a building structure housing a particular business establishment, a road, or an intersection, each identified via a respective sign employing a textual description or a formal name of the subject point of interest.

The data gathering and processing system 18 also includes a programmable electronic controller 26 in communication with the first and second sensors 20, 22. As shown in FIG. 1, the controller 26 is arranged on the autonomous vehicle 10 and may be integral to a central processing unit (CPU) 28. The controller 26 may be configured to use the captured raw data for various purposes such as to establish a 360-degree view of the terrain 14, to execute perception algorithms, etc. The controller 26 includes a memory that is tangible and non-transitory. The memory may be a recordable medium that participates in providing computer-readable data or process instructions. Such a medium may take many forms, including but not limited to non-volatile media and volatile media. Non-volatile media used by the controller 26 may include, for example, optical or magnetic disks and other persistent memory. The controller 26 includes an algorithm that may be implemented as an electronic circuit, e.g., FPGA, or as an algorithm saved to non-volatile memory. Volatile media of the controller 26 memory may include, for example, dynamic random-access memory (DRAM), which may constitute a main memory.

The controller 26 may communicate with the respective first and second sensors 20, 22 via a transmission medium, including coaxial cables, copper wire and fiber optics, including the wires in a system bus coupling a specific controller to an individual processor. Memory of the controller 26 may also include a flexible disk, hard disk, magnetic tape, other magnetic medium, a CD-ROM, DVD, other optical medium, etc. Controller 26 may be equipped with a high-speed primary clock, requisite Analog-to-Digital (A/D) and/or Digital-to-Analog (D/A) circuitry, input/output circuitry and devices (I/O), as well as appropriate signal conditioning and/or buffer circuitry. Algorithms required by the controller 26 or accessible thereby may be stored in the controller memory and automatically executed to provide the required functionality. Controller 26 may be configured, i.e., structured and programmed, to receive and process captured raw data signals gathered by the respective first and second sensors 20, 22.

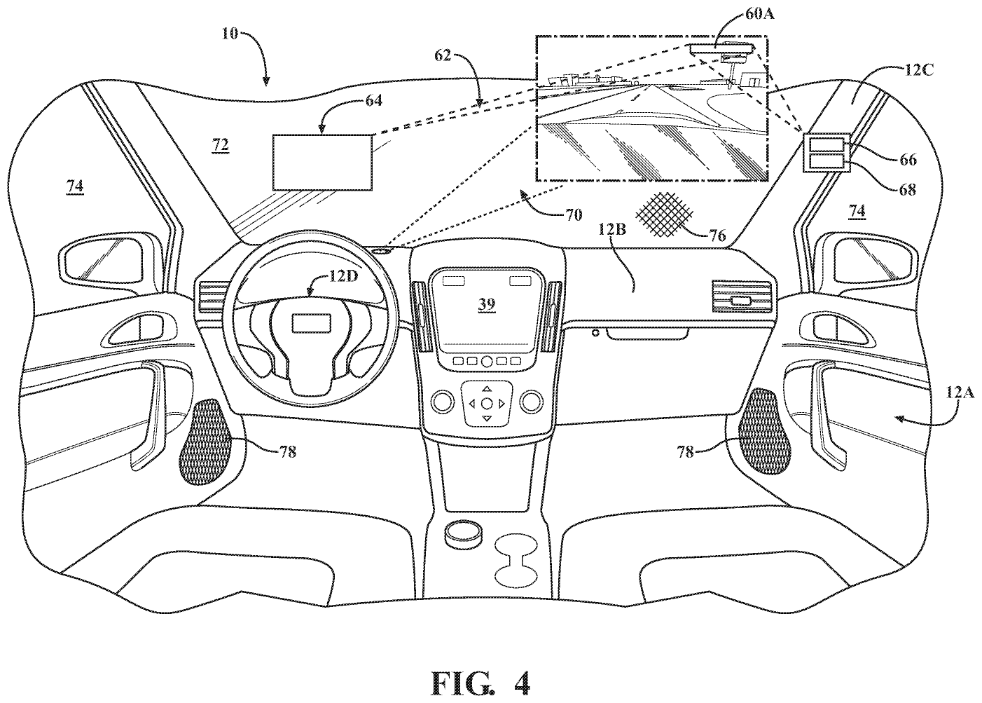

As shown, the electronic controller 26 includes a navigation module 30. Physically, the navigation module 30 may be arranged separately from the controller 26 or be housed therein. The navigation module 30 includes a map 32 of the geographical area with the terrain 14 stored within its memory, and is generally configured to establish navigation routes for guidance of the vehicle 10 through the terrain 14. The navigation module 30 is configured to determine a navigation route 34 to a particular destination 36 through the terrain 14, such as following a request for determination of the subject route by an operator of the vehicle 10. The controller 26 is specifically configured to access the navigation route 34 in the navigation module 30 or receive the navigation route therefrom. The navigation module 30 is generally configured to output the determined navigation route 34 and display the route on a navigation screen 39 (shown in FIG. 4) arranged in the vehicle cabin 12A.

As defined herein, the data gathering and processing system 18 also includes a global positioning system (GPS) 38 having earth-orbiting satellites in communication with the navigation module 30. The controller 26 is configured to receive from the GPS 38, such as via the navigation module 30, signal(s) 38A indicative of a current position of the GPS satellite(s) relative to the vehicle 10. The controller 26 is also configured to use the signal(s) 38A to determine a current position 40 of the vehicle 10 relative to the terrain 14. Generally, each GPS satellite continuously transmits a radio signal indicative of the current time and the satellite's position. Since the speed of radio waves is constant and independent of the GPS satellite speed, the time delay between when the satellite transmits a signal and the receiver receives it is proportional to the distance from the satellite to the receiver. The navigation module 30 typically monitors multiple satellites and solves equations to determine the precise position of the vehicle 10 and its deviation from true time. The navigation module 30 generally requires a minimum of four GPS satellites to be in view for the module to compute three position coordinates and the clock deviation from satellite time.

The controller 26 is additionally configured to determine a location 42 of a next waypoint 44, for example the external object 24, on the navigation route 34 and relative to the current position 40 of the vehicle 10. The controller 26 is also configured to issue a test query to the sensor 20 and receive therefrom an image frame 46 displaying a text 48 indicative of the next waypoint 42. The text 48 on the image frame 46 may, for example, be word(s) on a traffic, street, or business sign. The controller 26 is additionally configured to recognize and correlate the detected text 48 to the next waypoint 44 on the map 32 of the terrain 14. Furthermore, the controller 26 is configured to set an in-vehicle, such as inside the cabin 12A, alert 50 indicative of the detected text 48 having been correlated to the next waypoint 44.

The electronic controller 26 may be additionally configured to determine a distance 52 from the current position 40 of the vehicle 10 to the determined location 42 of the next waypoint 44. The electronic controller 26 may be additionally configured to determine whether the distance 52 from the current position 40 to the determined location 42 is within a threshold distance 54. The controller 26 may be further configured to set the alert 50 when the current position 40 of the vehicle 10 is within the threshold distance 54 of the next waypoint 44 and the text 48 is correlated to the next waypoint. The alert 50 may be set in a variety of audio and/or visual ways, each configured to indicate to the vehicle operator that the vehicle 10 is approaching the next waypoint 44.

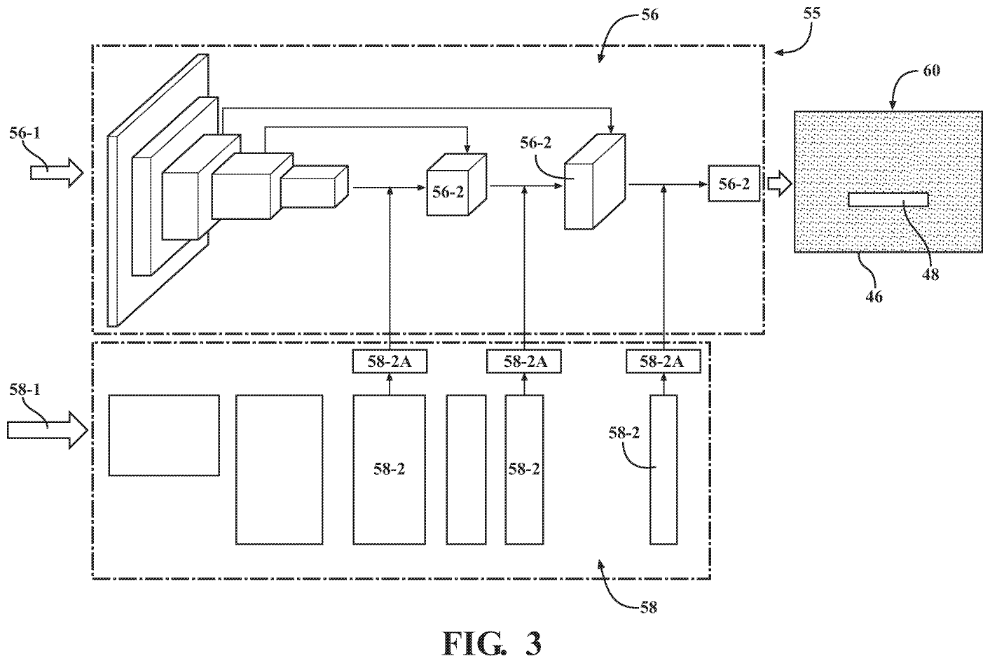

With continued reference to FIG. 1, the electronic controller 26 may employ a trained Neural Network architecture 55 to recognize text and image data gathered by the first sensor 20 as the vehicle 10 progresses along the navigation route 34 through the terrain 14. Specifically, the electronic controller 26 may be configured to correlate the detected text 48 to the next waypoint 44 via a trained Neural Network architecture 55. As shown in FIG. 3, the Neural Network architecture 55 may be a unified Neural Network structure configured to reconstruct the image frame 46. According to the present disclosure, the unified Neural Network structure may include a 2-dimensional fully-convolutional first Neural Network 56 having a first (image) input 56-1 and configured to recognize the text 48, and a 1-dimensional convolutional second Neural Network 58 having a second (text) input 58-1.

Generally, convolutional neural networks are used for image recognition. Convolutional neural networks employ fully-connected convolutional layers that work by learning a small set of weights which are applied one at a time as filters to small parts of the image. Weights are stored (in the convolutional layers) in a small matrix (often 3×3) which is dot producted with each pixel, i.e., the scalar quantities are multiplied, to produce a new pixel, thus acting as image filters. The new images produced by each neuron/filter in a convolutional layer are then combined and passed as the inputs to every neuron in the next layer, and so on until the end of the neural network is reached. There is often a single dense layer at the end of a convolutional neural network to turn the image output of the final convolutional layer into the numerical class prediction that the neural network is being trained to produce. A fully-convolutional neural network is much like a convolutional neural network, but without fully-connected layers, i.e., it is comprised purely of convolutional layers and possibly some max-pooling layers. The output layer of a fully-convolutional neural network is a convolutional layer, and the output of such a neural network is therefore an image.

As shown, the first Neural Network 56 includes multiple layers 56-2, while the second Neural Network 58 includes multiple layers 58-2. Outputs from multiple layers 58-2 are merged with corresponding layers 56-2 in the first Neural Network 56 using at least one fully-connected layer 58-2A. Discrete values generated by layers 58-2 may be added element-wise to respective layers 56-2, i.e., individually, element by element. The first Neural Network 56 and second Neural Network 58 are trained together to output a mask score 60 having the recognized text 48 located on the recognized image frame 46. Of note, although the second Neural Network 58 is specifically disclosed herein as a 1-dimensional convolutional model, a bi-direction recurrent neural network, or another word representation model may also be used.

As shown in FIG. 4, the electronic controller 26 may be additionally configured to determine a field of vision 62 from the vantage point of the operator or another predetermined occupant of the vehicle 10 and set the in-vehicle alert 50 in response to the determined field of vision. The field of vision 62 may be determined via detection of orientation 64 of vehicle occupant's eyes, such as by spot scanning via a micro-electro-mechanical systems (MEMS) mirror 66 and laser light emitting diodes (LEDs) 68 embedded, for example, in the vehicle's dashboard 12B or A-pillar 12C. Alternatively, detection of orientation 64 of vehicle occupant's eyes may be accomplished via an in-vehicle camera of a driver monitoring system, positioned for example in the vehicle dashboard 12B, A-pillar 12C, or on a steering wheel column 12D.

The data gathering and processing system 18 may include a head-up display (HUD) 70 generally used to project select vehicle data inside the cabin 12A to inform the vehicle operator thereof. Specifically, the electronic controller 26 may set the in-vehicle alert 50 using HUD 70 to project a visual signal, such as a highlight icon 60A representative of the mask score 60, onto a view of the next waypoint 44. Such a visual signal may, for example, be projected onto a view of the next waypoint 44 in a vehicle windshield 72 or one of the side windows 74, in response to the detected orientation of the vehicle occupant's eyes, i.e., when the next waypoint 44 comes into the field of vision 62. In addition to HUD 70, the highlight icon 60A may be projected via a micro-electro-mechanical systems (MFMS) mirror 66 and light emitting diodes (LEDs) 68 embedded in the vehicle's dashboard 12B or A pillar 12C, and reflecting into the vehicle occupant's field of vision 62 by the vehicle's windshield 72.

To affect projection of the icon 60A onto the view of the next waypoint 44, and thereby highlight the corresponding external object 24, in a particular example, the vehicle 10 may include a fluorescent film 76 with laser excitation attached to vehicle windshield 72 (shown in FIG. 4). In another embodiment, the in-vehicle alert 50 may be set by triggering an audible signal, such as via vehicle's audio speakers 78, to signify that the vehicle 10 is approaching the next waypoint 44, either as a stand-alone measure or accompanying the visual signal described above. Additionally, the electronic controller 26 may be configured to set the in-vehicle alert 50 via highlighting the next waypoint on the navigation route 34 displayed on the navigation screen 39 when the next waypoint 44 appears in the determined field of vision 62.

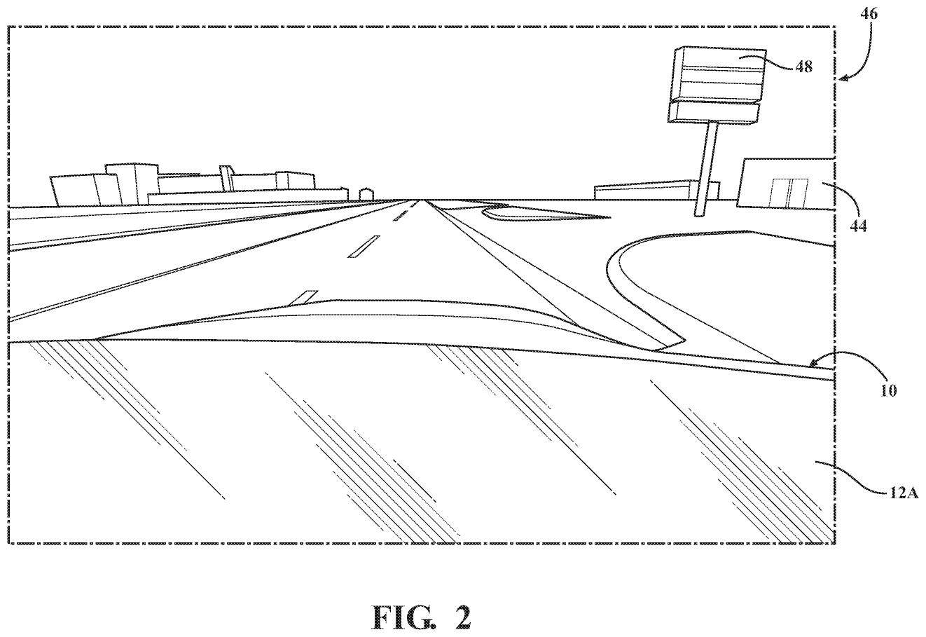

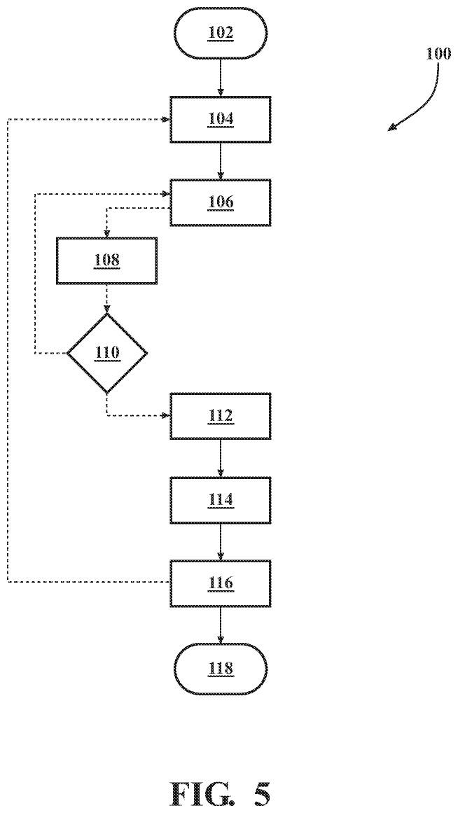

FIG. 5 depicts a method 100 of vehicle navigation using terrain text recognition used by the vehicle data gathering and processing system 18, as described above with respect to FIGS. 1-4. The method 100 may be performed via the system 18 utilizing the electronic controller 26 programmed with respective algorithms. The method 100 initiates in frame 102 with receiving, via the electronic controller 26, the navigation route 34 through the terrain 14. Following frame 102, the method proceeds to frame 104, where the method includes receiving, via the electronic controller 26, a signal 38A from the GPS 38, and using the signal 38A to determine the current position 40 of the vehicle 10 relative to the terrain 14. After frame 104, the method advances to frame 106. In frame 106 the method includes determining, via the electronic controller 26, the location 42 of the next waypoint 44 on the navigation route 34.

Following frame 106, the method may proceed to frame 108 or to frame 112. In frame 108 the method may include determining the distance 52 from the current position to the determined location 42 of the next waypoint 44, and then move to frame 110 for determining whether the distance 52 to the location 42 is within the threshold distance 54. If it is determined that the distance 52 of the determined location 42 of the next waypoint 44 is outside the threshold distance 54, the method may return to frame 106. If, on the other hand, it is determined that the distance 52 from the current position to the location 42 of the next waypoint 44 is within the threshold distance 54, the method may advance to frame 112. In frame 112 the method includes detecting and communicating to the electronic controller 26, via the sensor 20, the image frame 46 displaying the text 48 indicative of the next waypoint 44.

Following frame 112, the method moves on to frame 114. In frame 114, the method includes correlating, via the electronic controller 26, the detected text 48 to the next waypoint 44 on the map 32 of the terrain 14. According to the method, correlating the detected text 48 to the next waypoint 44 may include using the trained Neural Network architecture 55. As described above with respect to FIG. 3, the Neural Network architecture 55 may be a unified Neural Network structure configured to recognize the image frame 46 and include a fully-convolutional first Neural Network 56 having an image input 56-1 and configured to recognize the detected text 48, and a convolutional second Neural Network 58 having a text input 58-1. Each of the first Neural Network and the second Neural Network may include respective multiple layers 56-2, 58-2. Outputs from multiple layers 58-2 may be merged with corresponding multiple layers 56-2 using fully-connected layer(s) 58-2A. As described above, the first and second Neural Networks 56, 58 are intended to be trained together to output the mask score 60 having the recognized text 48 located on the recognized image frame 46. After frame 114, the method advances to frame 116.

In frame 116 the method includes setting, via the electronic controller 26, the in-vehicle alert 50 indicative of the detected text 48 having been correlated to the next waypoint 44. Accordingly, setting of the in-vehicle alert 50 may be performed when the distance 52 from the current position to the determined location 42 of the next waypoint 44 is within the threshold distance 54. Furthermore, setting the in-vehicle alert 50 may include projecting, via the HUD 70, the highlight icon 60A representative of the mask score 60 onto the view of the next waypoint 44. Additionally, in frame 116 the method may include determining the field of vision 62 of an occupant of the vehicle and setting the in-vehicle alert 50 in response to the determined field of vision.

As described above with respect to FIG. 4, determining the field of vision 62 may include detecting orientation 64 of vehicle occupant's eyes and setting the in-vehicle alert 50 may then include projecting the highlight icon 60A in response to the detected eye orientation. Alternatively, setting the in-vehicle alert 50 may, for example, include triggering an audible signal when the next waypoint 44 appears in the determined field of vision 62. Following completion of the setting of the in-vehicle alert 50 in frame 116, the method may return to frame 104 for continued determination of the vehicle 10 position along the route 34, and subsequent determination of the location of a new waypoint and another text query. Alternatively, if for example the vehicle has reached is chosen destination, following frame 116 the method may conclude in frame 118.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. A method of vehicle navigation using terrain text recognition, the method comprising:
receiving, via an electronic controller arranged on a vehicle and having access to a map of the terrain, a navigation route through the terrain;
receiving, via the electronic controller, a signal from a global positioning system (GPS) and using the signal to determine a current position of the vehicle relative to the terrain;
determining, via the electronic controller, a location of a next waypoint on the navigation route and relative to the current position of the vehicle;
detecting and communicating to the electronic controller, via a sensor arranged on the vehicle, an image frame displaying a text indicative of the next waypoint;
correlating, via the electronic controller, the detected text to the next waypoint on the map of the terrain; and
setting, via the electronic controller, an in-vehicle alert indicative of the detected text having been correlated to the next waypoint.

2. The method according to claim 1, further comprising determining, via the electronic controller, a distance from the current position to the determined location of the next waypoint.

3. The method according to claim 2, further comprising determining, via the electronic controller, whether the distance from the current position to the determined location of the next waypoint is within a threshold distance.

4. The method according to claim 3, wherein setting the in-vehicle alert is accomplished when the distance from the current position to the determined location of the next waypoint is within the threshold distance.

5. The method according to claim 1, wherein correlating the detected text to the next waypoint on the map of the terrain includes using a trained Neural Network architecture.

6. The method according to claim 5, wherein the Neural Network architecture is a unified Neural Network structure configured to recognize the image frame and including:
a fully-convolutional first Neural Network having an image input and at least one layer, and configured to recognize the text; and
a convolutional second Neural Network having a text input and at least one layer; and
wherein an output from the at least one layer of the second Neural Network is merged with the at least one layer of the first Neural Network, and the first and second Neural Networks are trained together to output a mask score.

7. The method according to claim 6, wherein setting the in-vehicle alert indicative of the detected text having been correlated to the next waypoint on the map of the terrain includes projecting, via a head-up display (HUD), a highlight icon representative of the mask score onto a view of the next waypoint.

8. The method according to claim 7, further comprising determining a field of vision of an occupant of the vehicle and setting the in-vehicle alert in response to the determined field of vision.

9. The method according to claim 8, wherein determining the field of vision includes detecting an orientation of the occupant's eyes and setting the in-vehicle alert includes projecting the highlight icon in response to the detected orientation of the vehicle occupant's eyes.

10. The method according to claim 8, wherein setting the in-vehicle alert includes triggering an audible signal when the next waypoint appears in the determined field of vision.

11. A system for vehicle navigation using terrain text recognition, the system comprising:
an electronic controller arranged on a vehicle and having access to a map of a terrain;
a global positioning system (GPS) in communication with the electronic controller; and
a sensor arranged on the vehicle, in communication with the electronic controller, and configured to detect objects of the terrain;
wherein the electronic controller is configured to:
receive a navigation route through the terrain;
receive a signal from the GPS and use the signal to determine a current position of the vehicle relative to the terrain;
determine a location of a next waypoint on the navigation route and relative to the current position of the vehicle;
receive from the sensor an image frame displaying a text indicative of the next waypoint;
correlate the detected text to the next waypoint on the map of the terrain; and
set an in-vehicle alert indicative of the detected text having been correlated to the next waypoint.

12. The system according to claim 11, wherein the electronic controller is also configured to determine a distance from the current position to the determined location of the next waypoint.

13. The system according to claim 12, wherein the electronic controller is additionally configured to determine whether the distance from the current position to the determined location of the next waypoint is within a threshold distance.

14. The system according to claim 13, wherein the electronic controller is configured to correlate the detected text to the next waypoint on the map of the terrain when the distance from the current position to the determined location of the next waypoint is within the threshold distance.

15. The system according to claim 11, wherein the electronic controller is configured to correlate the detected text to the next waypoint on the map of the terrain via a trained Neural Network architecture.

16. The system according to claim 15, wherein the Neural Network architecture is a unified Neural Network structure configured to recognize the image frame and including:
a fully-convolutional first Neural Network having an image input and at least one layer, and configured to recognize the text; and
a convolutional second Neural Network having a text input and at least one layer; and
wherein an output from the at least one layer of the second Neural Network is merged with the at least one layer of the first Neural Network, and the first and second Neural Networks are trained together to output a mask score.

17. The system according to claim 16, further comprising a head-up display (HUD), wherein the electronic controller is configured to set the in-vehicle alert via projecting, via the HUD, a highlight icon representative of the mask score onto a view of the next waypoint.

18. The system according to claim 17, wherein the electronic controller is additionally configured to determine a field of vision of an occupant of the vehicle and set the in-vehicle alert in response to the determined field of vision.

19. The system according to claim 18, wherein the field of vision is determined via detection of an orientation of the occupant's eyes and the in-vehicle alert includes projecting the highlight icon in response to the detected orientation of the vehicle occupant's eyes.

20. The system according to claim 18, wherein the electronic controller is configured to set the in-vehicle alert via triggering an audible signal when the next waypoint appears in the determined field of vision.
